(19) United States
(12) Patent Application Publication
(10) Pub. No.: US 2018/0204017 A1
(43) Pub. Date: Jul. 19, 2018

(54) SYSTEMS AND METHODS TO CONVERT A DATA SOURCE INTO A SECURE CONTAINER WITH DYNAMIC RIGHTS BASED ON DATA LOCATION

(71) Applicant: Vaultize Technologies Private Limited, Pune (IN)

(72) Inventors: Ankur Panchbudhe, Pune (IN); Praneeth Siva, Pune (IN); Amol Vaikar, Pune (IN); Yusuf Batterywala, Pune (IN)

(73) Assignee: Vaultize Technologies Private Limited, Pune (IN)

(21) Appl. No.: 15/920,151

(22) Filed: Mar. 13, 2018

(51) Int. Cl. G06F 21/62; G06F 3/06; G06F 12/14; G06F 21/60; H04L 9/08; H04L 9/32

(52) U.S. Cl. CPC G06F 21/6209; G06F 3/0623; G06F 3/0643; G06F 3/0644; G06F 2212/1052; G06F 21/602; H04L 9/0819; H04L 9/3242; G06F 12/1408

(57) ABSTRACT

System and method to convert a data source into a secure container with dynamic rights based on data location. The embodiments herein relate to data management and, more particularly, to performing data management by containerizing the data. Embodiments herein disclose a method and system for associating dynamic rights with data present in a data container, wherein the rights can be applied based on the location where from where the data is accessed.

### TECHNICAL FIELD

The embodiments herein relate to data management and, more particularly, to controlling data access by containerizing the data.

### BACKGROUND

Data management is one of the prime areas of concern of the modern world. The term ‘data management’ does not just address way of organizing data, but also focuses on data security aspects. With the increasing popularity of ‘Bring Your own Device (BYOD)’ trend, which allows users to use their personal device for professional/official use as well, data security concerns are at peak. BYOD allows users to access data belonging to the enterprise, which is of confidential nature, from any location. There is a need to keep corporate data separate from personal data and also to make sure that corporate data does not get leaked or lost just because the company does not own the device. Further, the personal devices of users may not possess sufficient security means to fight malware and similar fraudulent attacks, which poses high data security risk.

Data containerization is a technique/mechanism, which is used to protect data of the confidential nature, from unauthorized access. This may involve locking down the data to be protected, and providing access to a user only after a successful authentication check. In data containerization, there can be a plurality of data containers such as a corporate data container, a personal data container and so on. These containers are typically folders or databases, with each holding a particular kind of data with particular set of rights and rules.

Data containerization is typically achieved by controlling the access and movement of files in and out of individual container folders. Administrators of the data need to control access to this data so as to prevent data leaks and at the same time should not be very restrictive to hinder productivity. A current approach to enforce rights is to encrypt files using existing DRM/IRM (Digital Rights Management/Information Rights Management) techniques. However, when a DRMed/IRMed file is shared/copied to another location, then, original rights will be applied to the copied data. If original rights are restrictive, then, even the owners/administrators will have restrictive rights, thereby decreasing the productivity. If the rights are permissive, then, the copied data will also have permissive rights, thereby data can be leaked.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 depicts a rights manager connected to a plurality of devices, according to embodiments as disclosed herein;

FIG. 2 depicts a containerized file, according to embodiments as disclosed herein;

FIG. 3 depicts the rights manager, according to embodiments as disclosed herein

FIG. 4 depicts a device containerizing a file, according to embodiments as disclosed herein;

FIG. 5 depicts a device attempting to access a containerized file, according to embodiments as disclosed herein;

FIG. 6 depicts a flowchart for containerizing data, according to embodiments as disclosed herein; and

FIG. 7 depicts a flowchart for accessing containerized data, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

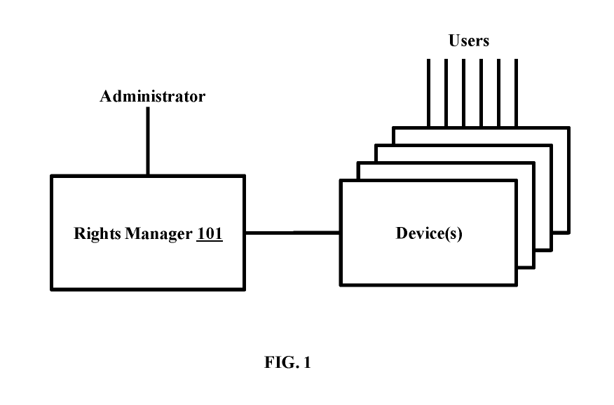

The embodiments herein achieve methods and systems for associating dynamic rights with data present in a data container, wherein the rights can be applied based on the location from where the data is accessed. Referring now to the drawings, and more particularly to FIGS. 1 through 7, where similar reference characters denote corresponding features consistently throughout the figures, there are shown preferred embodiments.

Data containerization refers to creating a secured data store (container) on a device or within an application, wherein the data files and/or folders (hereinafter collectively referred to as files) present in the container are a logical collection. The container can be defined using a plurality of parameters such as geo-location of the device comprising the file, Internet Protocol (IP) address(es) of the device comprising the file, Fully Qualified Domain Names (FQDNs), Media Access Control (MAC) addresses, host IDs, time of access and folder/file/set/collection/labels/tags or similar file and/or device location information. Access to data present in the data container requires secure authentication, independent of any other device settings or restriction. On a device with no unlock pass-code, no whole device encryption, and no security policies of any type, the contents of the container remain inaccessible unless an authorized user enters valid credentials (for example, a password or a username-password combination). Securing data in a container also allows an administrator to wipe official data from a personal device without wiping any personal data or applications by simply deleting the container. Rather than making sure the entire device is secure, which can limit the end-user from being able to use a device to its full potential, the containerization creates a compartment within the device, where the corporate data and applications are segregated from the user's other applications and data.

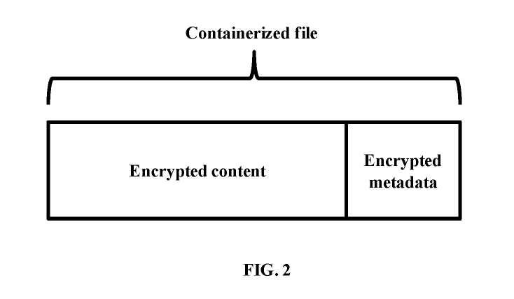

A containerized data file comprises of encrypted contents of the file and encrypted metadata (as depicted in FIG. 2). The encrypted metadata can help in determining the file's access rights at any given time, given location and given usage. The metadata can be encrypted based on at least one unique identification means for the file location and/or the device such as geo-location of the device comprising the file, IP address(es) of the device comprising the file, FQDNs, MAC addresses, host IDs, time of access and folder/file/set/collection/labels/tags or similar file and/or device location information.

Embodiments herein disclose methods and systems for associating dynamic rights with data present in a data container, wherein the rights can be applied based on the location where from where the data is accessed. Embodiments herein enable permissive permissions to be defined, if the data present in a data container is accessed from the data container and/or at the same location where the data container is located. Embodiments herein enable restrictive permissions to be defined, if the data present in a data container is accessed outside of the data container or a different location from where the data container is located.

FIG. 1 depicts a rights manager connected to a plurality of devices, according to embodiments as disclosed herein. The rights manager 101 can be connected to at least one device 102, wherein the device can be at least one of a source of files (which are to be containerized or which have already been containerized), or a device used by the user to access the files (which have been containerized). The files can be information, software, emails, applications, databases, software code, and so on, wherein the files can be in the form of documents (Microsoft Office Formats, PDF, Open Document formats and so on), images, media files, lists (Comma Separated values, Spreadsheets), drawings, schematics, blue-prints, ECM repositories (SharePoint, Documentum, and so on), content management systems, and so on. The files can also refer to folders and/or archives, which comprise of a plurality of files.

The rights manager 101 can interface with at least one device 102, wherein the user can use this at least one device to access the data. The device 102 can be at least one of a computer, a laptop, a tablet, a mobile device, a wearable computing device, a file server, a database server, a content management server, an application server, a memory, an IoT (Internet of Things) device, a wearable computing device, or any other device which will enable a user of the device 102 to access data, containerize data, access containerized data and so on. The memory can be a dedicated memory device such as a hard disk, a SSD (Solid State Drive) and so on. The memory can also be a part of a device associated with an enterprise network such as a desktop, a laptop, a device belonging to a user (such as in a BYOD (Bring Your Own Device) scenario) such as a mobile phone, a tablet, a personal computing device and so on, wherein the rights manager 101 has access to the memory. The user can be an employee, a contractor, an agent, a client or any person and/or organization/enterprise, attempting to access the data (with authorization from the enterprise who owns the data or without appropriate authorization).

An administrator can be authorized to access the rights manager 101, wherein the administrator can view the data, data containers comprising of at least one data, associated access and rights, change the associated access and rights and so on. The data containers can comprise of data spread across one or more sources.

In an embodiment herein, the rights manager 101 can be a dedicated device such as a server, which is connected to the sources of data. In another embodiment herein, the rights manager 101 can be present on a device/server (for example, as an application, plugin, extension and so on) and can perform analysis of the content of the data present on that device; assign access and rights to each set of data (based on the analysis of the content of the data) present on that device and control access to the data based on the access rights associated with the data present on that device. In another embodiment herein, the rights manager 101 can be present on a device/server (for example, as an application, plugin, extension and so on) and can perform analysis of the content of the data present on that device and at least one other device; assign access and rights to each set of data (based on the analysis of the content of the data) present on that device and at least one other device and control access to the data based on the access and rights associated with the data present on that device and at least one other device. In another embodiment herein, the rights manager 101 can be a distributed device, wherein the functionality of the rights manager 101 is distributed over one or more devices; such as a server and a device used by the user and so on.

The rights manager 101 can be configured to act as a means for managing the rights associated with data containers. The rights manager 101 can enable the administrator to define a fence restriction for the data which is to be included in the container, wherein the fence restriction can include one or more devices. The rights manager 101 can also enable the administrator to define access rights for files. The rights manager 101 can also enable the administrator to define additional parameters such as passwords, expiry of access, and so on. The rights manager 101 can also enable the administrator to define creation of multi-layer containers.

The rights manager 101 can contain of at least one encryption key. The encryption key can comprise of at least one of a random string, a N-bit key (wherein examples of N can be, but not limited to, 128, 256, 512, 1024, 2048, and so on), a public key, a symmetric key, and so on.

The device 102a can fetch the encryption key from the rights manager 101 and can encrypt the files using the encryption key, based on the inputs from the administrator. The device 102a can compute a unique identification means for the device 102a (herein after referred to as Host ID). The device 102a can compute the Host ID by hashing a unique identification means for the device 102a (such as MAC address, GUID (Globally Unique Identifier), UUID (Universally Unique Identifier), IP address, FDQN/domain name, URL, installed unique random key and so on) and the encryption key, as fetched from the rights manager 101. The device 102a can include the Host ID within the metadata associated with the containerized file. The device 102a can also include the path of the file in the metadata.

A device 102b (which can or cannot be the same device as the device 102b that containerized the file (as described above)) on detecting that an attempt is being made to access a containerized file, can contact the rights manager 101. The rights manager 101 can provide information such as the rights associated with the containerized file, fence restrictions (if any) and so on. In an embodiment herein, the rights associated with the containerized file, fence restrictions and so on, can be available with the device 102b. The rights manager 101 can provide the encryption keys to the device 102b. The device 102b can compute the Host ID, using the encryption keys and a unique identification means for the device 102b. The device 102b can decrypt the metadata associated with the containerized file. The device 102b can check if the computed Host ID matches with the Host ID embedded in the metadata of the containerized file.

The device 102b can further compare the path of the file embedded in the metadata with the current path of the location of the containerized file.

If the computed Host ID matches with the embedded Host ID and the embedded path matches the current path of the containerized file, the device 102b can determine that the containerized file is present inside the container. The device 102b can open the containerized file, by applying corresponding rights assigned for when the containerized file is present inside the container.

If the computed Host ID does not match with the embedded Host ID and the embedded path does not match the current path of the containerized file, the device 102b can determine that the containerized file is present outside the container and/or the device 102a. The device 102b can open the containerized file, by applying corresponding rights assigned for when the containerized file is present outside the container and/or the device 102a.

If the rights manager 101 is offline, the device 102b can sync offline rights to the file with the rights manager 101, for enabling offline access. The rights manager 101 can track actions taken with respect to containerized files and store the actions. The device 102b can sync the actions with the rights manager 101 in real-time. The device 102b can sync the actions with the rights manager, when the rights manager 101 comes online. The device 102b can sync the actions with the rights manager 101 at periodic intervals or on a pre-defined event occurring.

The rights manager 101 can containerize a file, which matches pre-defined criteria, on the file being moved and/or created in a predefined location.

Depending on the rights available to the device 102b, the device 102b and the rights manager 101 can delete containers and file(s) present in the containers. On deletion of a container, the file(s) present in the container are de-containerized. The rights manager 101 can auto-wipe the containers and any copied instances of the containers or the files present in the containers can be deleted. The rights manager 101 can further change at least one property associated with the container. The rights manager 101 can also set at least one property (such as permissions) for individual files present in a container.

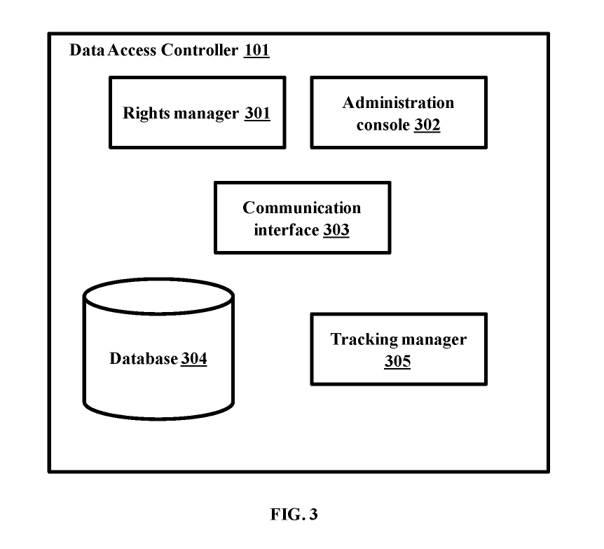

FIG. 3 depicts the rights manager, according to embodiments as disclosed herein. The rights manager 101, as depicted comprises of a containerization manager 301, an administrator console 302, a communication interface 303, a database 304, and a tracking manger 305. The communication interface 303 can enable the rights manager 101 to communicate with at least one external entity, such as a data source, a device 102 (attempting to containerize a file or access a containerized file) and so on. The communication interface 303 can comprise of at least one of a LAN (Local Area Network) interface, a WAN (Wide Area Network) interface, IPC (Inter Process Communication), a wireless communication interface (Wi-Fi, cellular communications, Bluetooth and so on), the Internet, a private network interface and so on. The communication interface 303 can also enable the rights manager 101 to interact with other external entities such as user(s), administrator(s) and so on. The communication interface 303 can comprise of at least one of a web UI access, Application based Interface (API)-based access, FTP (File Transfer Protocol), SFTP (Secure FTP), FTPS (FTP Secure), SMTP (Simple Mail Transfer Protocol), CIFS/SMB (Common Internet File System/Server Message Block), NFS (Network File System), CMIS (Content Management Interoperability Services), ActiveSync, DAV (Distribution Authoring and Versioning), WebDAV, HTTP (Hypertext Transfer Protocol), HTTPS (HTTP Secure) and so on.

The database 304 can be a memory storage location, wherein the database 304 can be a pure database, a memory store, an electronic storage location and so on. The database 304 can be located locally with the rights manager 101. The database 304 can be located remotely from the rights manager 101, wherein the rights manager 101 can communicate with the database 304 using a suitable means such as LAN, a private network, a WAN, the Internet, Wi-Fi and so on. The database 304 can comprise of policy rule(s) (as set by the administrator) for the data containers, default policy rule(s) for the data containers, and so on. The database 304 can comprise of at least one encryption key. The database 304 can also comprise of Host IDs computer for each containerized file by a device 102. The database 304 can also comprise of rights, fences, or any other property associated with a containerized file.

The containerization manager 301 can act as a means for managing the rights associated with data containers. The containerization manager 301 can enable the administrator to define a fence restriction for the data which is to be included in the container, using the administrator console 302. The fence restriction can be in the form of an IP address, a range of IP addresses, domain name(s), MAC address(es), time, file properties, and so on. The containerization manager 301 can also enable the administrator to define access rights for files, using the administrator console 302. The administrator console 302 can enable the administrator to define access rights for when the data is present inside the container, on the same device as the container, outside the container, and so on. In an example, the administrator can define rights such that a file on a file server should be modifiable if accessed directly from the server, but any copy of the file should have only read only permissions, if not accessed from the server. The administrator console 302 can also enable the administrator to define offline access rights, for when the offline access rights can be applicable when the rights manager 101 is not accessible to the device accessing the file. The administration console 302 can also enable the administrator to define additional parameters such as passwords, expiry of access, and so on. The administration console 302 can also enable the administrator to define creation of multi-layer containers.

The containerization manager 301 can provide at least one encryption key to a device 102, on receiving a request from the device 102. The containerization manager 301 can also store the encryption keys sent to the device 102 in the database 304, in a manner so as to link the device 102, the file that was containerized using the encryption key and the encryption key. The containerization manager 301 can also communicate at least one option as set by the administrator to the device 102.

The containerization manager 301 can provide information such as the rights associated with the containerized file, fence restrictions (if any) and so on, on receiving a request from a device 102b which is attempting to access the containerized file. The containerization manager 301 can provide the encryption keys to the device 102b. The containerization manager 301 can fetch the information to be provided to the database 304 from a suitable location, such as the database 304.

The tracking manager 305 can track actions taken with respect to containerized files and store the actions in a suitable location such as the database 304 (either directly or using the containerization manager 301). The tracking manger 305 can sync the actions with the device 102b in real-time. The tracking manger 305 can sync the actions with the device 102b, when the rights manager 101 comes online. The tracking manger 305 can sync the actions with the device 102b at periodic intervals or on a pre-defined event occurring.

The containerization manager 301 can containerize a file on a device 102, which matches pre-defined criteria, on the file being moved and/or created in a predefined location.

Depending on the rights available to the device 102b, the containerization manager 301 can delete containers and file(s) present in the containers. On deletion of a container, the file(s) present in the container are de-containerized. The containerization manager 301 can auto-wipe the containers and any copied instances of the containers or the files present in the containers can be deleted. The containerization manager 301 can further change at least one property associated with the container. The containerization manager 301 can also set at least one property (such as permissions) for individual files present in a container.

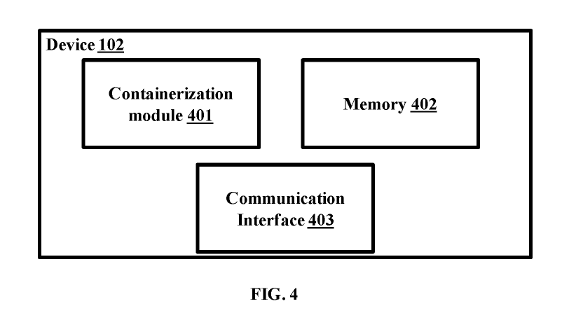

FIG. 4 depicts a device containerizing a file, according to embodiments as disclosed herein. The device 102 comprises of a containerization module 401, a memory 402, and a communication interface 403.

The communication interface 403 can enable the device 102 to communicate with at least one external entity, such as a data source, the rights manager 101 (attempting to containerize a file or access a containerized file) and so on. The communication interface 403 can comprise of a LAN (Local Area Network) interface, a WAN (Wide Area Network) interface, IPC (Inter Process Communication), a wireless communication interface (Wi-Fi, cellular communications, Bluetooth and so on), the Internet, a private network interface and so on. The communication interface 403 can also enable the device 102 to interact with other external entities such as user(s), administrator(s) and so on. The communication interface 403 can comprise of at least one of a web UI access, Application based Interface (API)-based access, FTP (File Transfer Protocol), SFTP (Secure FTP), FTPS (FTP Secure), SMTP (Simple Mail Transfer Protocol), CIFS/SMB (Common Internet File System/Server Message Block), NFS (Network File System), CMIS (Content Management Interoperability Services), ActiveSync, DAV (Distribution Authoring and Versioning), WebDAV, HTTP (Hypertext Transfer Protocol), HTTPS (HTTP Secure) and so on.

The memory 402 can be a memory storage location, wherein the memory 402 can be a pure database, a memory store, an electronic storage location and so on. The database 304 can be located locally with the device 102. The memory 402 can be located remotely from the device 102, wherein the device 102 can communicate with the memory 402 using a suitable means such as LAN, a private network, a WAN, the Internet, Wi-Fi and so on. The memory 402 can comprise of an internal memory, an external memory, an expandable memory and so on. The memory 402 can comprise of policy rule(s) (as set by the administrator) for the data containers, default policy rule(s) for the data containers, and so on. The memory 402 can comprise of at least one encryption key. The memory 402 can also comprise of Host IDs computer for each containerized file. The memory 402 can also comprise of rights, fences, or any other property associated with a containerized file.

On receiving an indication to containerize a file, the containerization module 401 can send a request to the rights manager 101, using the communication interface 403. The containerization module 401 can receive the encryption key from the rights manager 101, through the communication interface 403. The containerization module 401 can encrypt the files using the encryption key, based on the inputs from the administrator. The containerization module 401 can compute a unique identification means for the device 102a (herein after referred to as Host ID). The containerization module 401 can compute the Host ID by hashing a unique identification means for the device 102a (such as MAC address, GUID, UUID, IP address, FDQN/domain name, URL, installed unique random key and so on) and the encryption key, as fetched from the rights manager 101. The containerization module 401 can include the Host ID within the metadata associated with the containerized file. The containerization module 401 can also include the path of the file in the metadata. The containerization module 401 can then store the containerized file in a suitable location such as the memory 402.

The containerization module 401 can track actions taken with respect to containerized files and store the actions. The containerization module 401 can sync the actions with the rights manager 101 in real-time. The containerization module 401 can sync the actions with the rights manager, when the rights manager 101 comes online. The containerization module 401 can sync the actions with the rights manager 101 at periodic intervals or on a pre-defined event occurring.

The containerization module 401 can containerize a file, which matches at least one pre-defined criteria, on the file being moved and/or created in a predefined location.

Depending on the rights available, the containerization module 401 can delete containers and file(s) present in the containers. On deletion of a container, the file(s) present in the container are de-containerized. The containerization module 401 can auto-wipe the containers and any copied instances of the containers or the files present in the containers can be deleted. The containerization module 401 can further change at least one property associated with the container. The containerization module 401 can also set at least one property (such as permissions) for individual files present in a container.

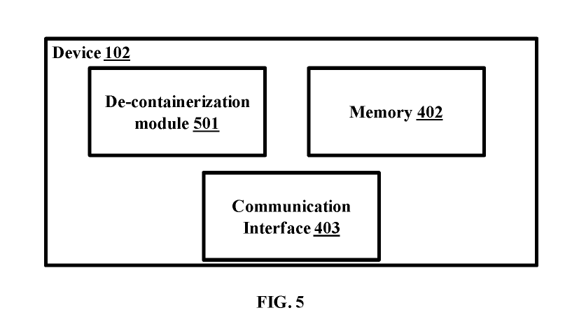

FIG. 5 depicts a device attempting to access a containerized file, according to embodiments as disclosed herein. The device 102 attempting to access a containerized file can be a different device, from the device 102 which containerized the file (as in FIG. 4). The device 102 comprises of a de-containerization module 501, a memory 402, and a communication interface 403.

The communication interface 403 can enable the device 102 to communicate with at least one external entity, such as a data source, the rights manager 101 (attempting to containerize a file or access a containerized file) and so on. The communication interface 403 can comprise of a LAN (Local Area Network) interface, a WAN (Wide Area Network) interface, IPC (Inter Process Communication), a wireless communication interface (Wi-Fi, cellular communications, Bluetooth and so on), the Internet, a private network interface and so on. The communication interface 403 can also enable the device 102 to interact with other external entities such as user(s), administrator(s) and so on. The communication interface 403 can comprise of at least one of a web UI access, Application based Interface (API)-based access, FTP (File Transfer Protocol), SFTP (Secure FTP), FTPS (FTP Secure), SMTP (Simple Mail Transfer Protocol), CIFS/SMB (Common Internet File System/Server Message Block), NFS (Network File System), CMIS (Content Management Interoperability Services), ActiveSync, DAV (Distribution Authoring and Versioning), WebDAV, HTTP (Hypertext Transfer Protocol), HTTPS (HTTP Secure) and so on.

The memory 402 can be a memory storage location, wherein the memory 402 can be a pure database, a memory store, an electronic storage location and so on. The database 304 can be located locally with the device 102. The memory 402 can be located remotely from the device 102, wherein the device 102 can communicate with the memory 402 using a suitable means such as LAN, a private network, a WAN, the Internet, Wi-Fi and so on. The memory 402 can comprise of an internal memory, an external memory, an expandable memory and so on. The memory 402 can comprise of policy rule(s) (as set by the administrator) for the data containers, default policy rule(s) for the data containers, and so on. The memory 402 can comprise of at least one encryption key. The memory 402 can also comprise of Host IDs computer for each containerized file. The memory 402 can also comprise of rights, fences, or any other property associated with a containerized file.

The de-containerization module 501 on detecting that an attempt is being made to access a containerized file, can contact the rights manager 101, using the communication interface 403. The de-containerization module 501 receives information such as the rights associated with the containerized file, fence restrictions (if any), encryption keys and so on from the rights manager 101, using the communication interface 403. In an embodiment herein, the de-containerization module 501 can fetch the rights associated with the containerized file, fence restrictions, encryption keys and so on, from a suitable storage location such as the memory 402. The de-containerization module 501 can compute the Host ID, using the encryption keys and a unique identification means for the device 102. The de-containerization module 501 can decrypt the metadata associated with the containerized file. The de-containerization module 501 can check if the computed Host ID matches with the Host ID embedded in the metadata of the containerized file.

The de-containerization module 501 can further compare the path of the file embedded in the metadata with the current path of the location of the containerized file.

If the computed Host ID matches with the embedded Host ID and the embedded path matches the current path of the containerized file, the de-containerization module 501 can determine that the containerized file is present inside the container. The de-containerization module 501 can open the containerized file using an inbuilt client/application or an external client/application, by applying corresponding rights assigned for when the containerized file is present inside the container.

If the computed Host ID does not match with the embedded Host ID and the embedded path does not match the current path of the containerized file, the de-containerization module 501 can determine that the containerized file is present outside the container and/or the device 102a. The de-containerization module 501 can open the containerized file using an inbuilt client/application or an external client/application, by applying corresponding rights assigned for when the containerized file is present outside the container and/or the device 102b.

In an embodiment herein, the de-containerization module 501 can use a verification means such as a password, biometric identification means and so on to verify the identity of the user accessing the containerized file, before providing access to the containerized file.

If the rights manager 101 is offline, the de-containerization module 501 can sync offline rights to the file with the rights manager 101, for enabling offline access. The de-containerization module 501 can sync the actions with the rights manager 101 in real-time. The de-containerization module 501 can sync the actions with the rights manager 101, when the rights manager 101 comes online. The de-containerization module 501 can sync the actions with the rights manager 101 at periodic intervals or on a pre-defined event occurring.

Depending on the rights available to the device 102b, the containerization module 401 can delete containers and file(s) present in the containers. On deletion of a container, the file(s) present in the container are de-containerized. The containerization module 401 can auto-wipe the containers and any copied instances of the containers or the files present in the containers can be deleted. The containerization module 401 can further change at least one property associated with the container. The containerization module 401 can also set at least one property (such as permissions) for individual files present in a container.

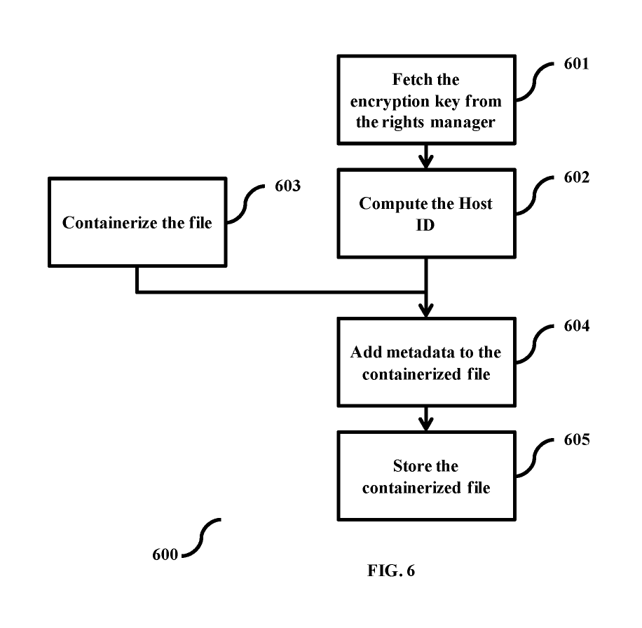

FIG. 6 depicts a flowchart for containerizing data, according to embodiments as disclosed herein. The device 102a fetches (601) the encryption key from the rights manager 101. The device 102a computes (602) the Host ID by hashing the unique identification means for the device 102a and the encryption key, as fetched from the rights manager 101. The device 102a containerizes (603) the file and adds (604) metadata to the containerized file. The metadata comprises of the Host ID and the path of the file. The device 102a stores (605) the containerized file in a suitable location. The various actions in method 600 may be performed in the order presented, in a different order or simultaneously. Further, in some embodiments, some actions listed in FIG. 6 may be omitted.

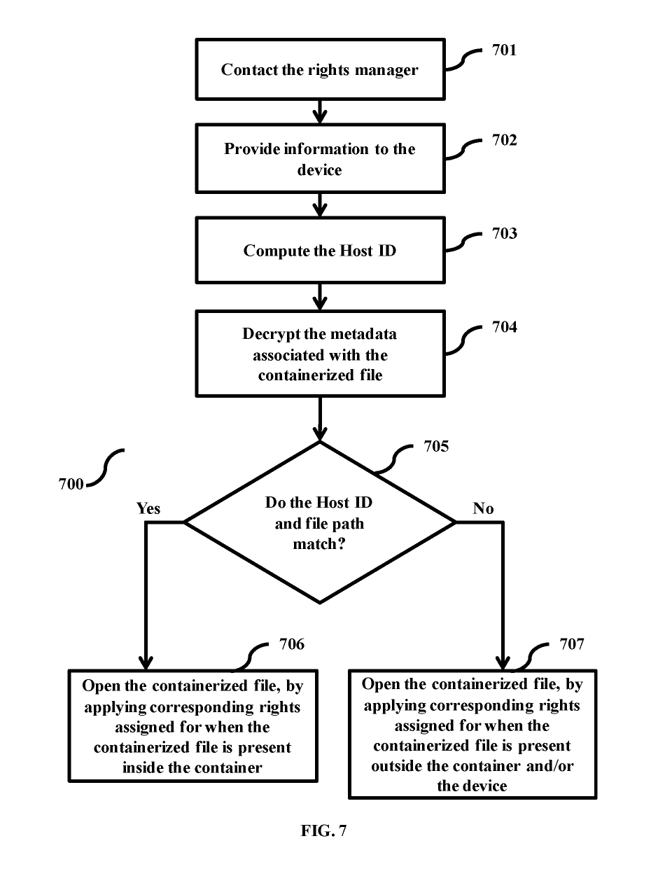

FIG. 7 depicts a flowchart for accessing containerized data, according to embodiments as disclosed herein. The device 102b on detecting that an attempt is being made to access a containerized file, contacts (701) the rights manager 101. The rights manager 101 provides (702) information such as the rights associated with the containerized file, fence restrictions (if any), encryption keys and so on. The device 102b computes (703) the Host ID, using the encryption keys and a unique identification means for the device 102b. The device 102b decrypts (704) the metadata associated with the containerized file. The device 102b compares (705) the computed Host ID with the Host ID. If the computed Host ID matches with the embedded Host ID, the device 102b can determine that the containerized file is present inside the container; the device 102b opens (706) the containerized file, by applying corresponding rights assigned for when the containerized file is present inside the container. If the computed Host ID does not match with the embedded Host ID and/or the embedded path does not match the current path of the containerized file, the device 102b can determine that the containerized file is present outside the container and/or the device 102a; the device 102b opens (707) the containerized file, by applying corresponding rights assigned for when the containerized file is present outside the container and/or the device 102a. In an embodiment herein, the device 102b can further attempt to match the file path embedded in the metadata with the current path of the location of the containerized file, to determine if the containerized file is present outside the container and/or device 102a. The various actions in method 700 may be performed in the order presented, in a different order or simultaneously. Further, in some embodiments, some actions listed in FIG. 7 may be omitted.

It may be obvious to a person of ordinary skill in the art to extend embodiments as disclosed herein to multilayer containers by embedding layered information into the metadata.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for containerizing at least one file, the method comprising of
computing a HOST ID by a device by hashing a unique identification means for the device containing the at least one file and an encryption key; and
containerizing the at least one file by the device, wherein the container comprises of the at least one file and metadata, further the metadata comprises the HOST ID.

2. The method, as claimed in claim 1, wherein the encryption key is made available by a rights manager.

3. The method, as claimed in claim 1, wherein the metadata further comprises of path of the at least one file.

4. The method, as claimed in claim 1, wherein the method further comprises of associating at least one access right with the at least one file, wherein rights for a user accessing the at least one file from inside the container are different from rights for a user accessing the at least one file from outside the container.

5. The method, as claimed in claim 1, wherein the data container is at least one of a single layer container or a multi-layer container.

6. A method for accessing a data container, the method comprising of
computing a HOST ID for a first device accessing the data container by a second device by hashing a unique identification means for the second device containing the at least one file and an encryption key;
comparing the computed HOST ID with a HOST ID embedded in metadata of the data container by the second device; and
applying corresponding rights to at least one file present in the data container by the second device, based on the comparison of the computed HOST ID and the HOST ID embedded in the metadata.

7. The method, as claimed in claim 6, wherein the method further comprises of comparing file path of the at least one file and file path present in the metadata.

8. The method, as claimed in claim 6, wherein the method further comprises of syncing at least one right related to the data container.

9. The method, as claimed in claim 6, wherein the method further comprises of enabling offline access to the data container.

10. The method, as claimed in claim 6, wherein the data container is at least one of a single layer container or a multi-layer container.

11. A system for containerizing at least one file, the system configured for
computing a HOST ID by hashing a unique identification means for a device containing the at least one file and an encryption key; and
containerizing the at least one file, wherein the container comprises of the at least one file and metadata, further the metadata comprises the HOST ID.

12. The system, as claimed in claim 11, wherein the encryption key is made available by a rights manager.

13. The system, as claimed in claim 11, wherein the metadata further comprises of path of the at least one file.

14. The system, as claimed in claim 11, wherein the system is further configured for associating at least one access right with the at least one file, wherein rights for a user accessing the at least one file from inside the container are different from rights for a user accessing the at least one file from outside the container.

15. The system, as claimed in claim 11, wherein the data container is at least one of a single layer container or a multi-layer container.

16. A system for enabling access to a data container, the system configured for
computing a HOST ID for a first device accessing the data container by hashing a unique identification means for a second device containing the at least one file and an encryption key;
comparing the computed HOST ID with a HOST ID embedded in metadata of the data container; and
applying corresponding rights to at least one file present in the data container, based on the comparison of the computed HOST ID and the HOST ID embedded in the metadata.

17. The system, as claimed in claim 16, wherein the system is configured for comparing file path of the at least one file and file path present in the metadata.

18. The system, as claimed in claim 16, wherein the system is configured for syncing at least one right related to the data container.

19. The system, as claimed in claim 16, wherein the system is configured for enabling offline access to the data container.

20. The system, as claimed in claim 16, wherein the data container is at least one of a single layer container or a multi-layer container.
